(19) United States
(12) Patent Application Publication
(10) Pub. No.: US 2012/0319982 A1
(43) Pub. Date: Dec. 20, 2012

(54) TERMINAL DEVICE AND METHOD OF CONTROLLING TERMINAL SYSTEM

(75) Inventor: Yukio Sato, Kanagawa (JP)

(73) Assignee: PANASONIC CORPORATION, OSAKA (JP)

(21) Appl. No.: 13/582,174

(22) PCT Filed: Mar. 2, 2011
(86) PCT No.: PCT/JP2011/001228

§ 371 Date: Aug. 31, 2012

(51) Int. Cl. G06F 3/041

(52) U.S. Cl. 345/173

(57) ABSTRACT

A terminal device is provided enabling automatic switching of an LCD display of a slave device to a touch panel manipulation screen when a master and the slave devices are unified; particularly, a compact, highly convenient terminal device and a method of controlling a terminal system that enables removal and attachment of a plurality of terminals. The terminal device has a structure in which a slave terminal having a unification/separation detection section, an LCD display screen, and a short range wireless communication section is inserted into a master terminal having a unification/separation detection section, a touch panel, and a short range wireless communication section, the compact touch panel being provided in the master terminal at a position where the compact touch panel overlaps the LCD display screen of the slave terminal, and short range wireless communication sections can perform linked communication control of the master and slave terminals.

### TECHNICAL FIELD

The present invention relates to a terminal device having a configuration in which two terminals, or a master device and a slave device, can be unified or separated from each other.

### BACKGROUND ART

A hitherto available terminal device of this type having a configuration that enables unification and separation of two terminals is described in; for instance, Patent Literature 1.

### CITATION LIST

### Patent Literature

Patent Literature 1: JP-A-2003-8736

### SUMMARY OF THE INVENTION

### Technical Problem

However, under the related art technique, combination of a master terminal with a slave terminal results in an increase in the size of the terminal device.

Accordingly, a structure, such as a structure for inserting a slave device into a master device, is conceivable to miniaturize the terminal device. However, in the case of such a structure, since the slave device is included in the master device, a problem occurred at this time is that the slave device cannot be operated while the slave device is inserted in the master device.

In order to solve the problem, the present invention aims at providing a compact, highly convenient terminal device while enabling removal attachment of a plurality of terminals.

### Solution to Problem

A terminal device of the present invention includes:

a first terminal having a touch panel and

a second terminal having a display screen,

wherein the second terminal can be accommodated in the first terminal;

the touch panel is positioned immediately above the display screen while the second terminal remains accommodated in the first terminal; and

the second terminal displays a touch panel manipulation screen on the display screen when the second terminal is accommodated in the first terminal, and the first terminal transmits to the second terminal input information entered by way of the touch panel.

As a result, the slave device can be readily operated while accommodated in the master device.

### Advantageous Effects of the Invention

The present invention can provide a compact, highly convenient terminal device and a method of controlling a terminal system while enabling removal attachment of a plurality of terminals.

### BRIEF DESCRIPTION OF THE DRAWINGS

FIG. 1A is a schematic structural diagram of a unified state of a first embodiment of the present invention, and FIG. 1B is a schematic structural diagram of a separated state of the first embodiment of the present invention.

FIG. 2 is a hardware block diagram of a slave terminal of the embodiment of the present invention.

FIG. 3 is a hardware block diagram of a master terminal of the first embodiment of the present invention.

FIG. 4 is an operation processing flow chart of the first embodiment of the present invention.

FIG. 5 is a hardware block diagram of a master terminal of a second embodiment of the present invention.

FIG. 6 is an operation processing flow chart of the second embodiment of the present invention.

FIG. 7 is a diagram showing an example display of the slave terminal appeared when it is separated in the embodiment of the present invention.

FIG. 8 is a diagram showing an example display of the slave terminal appeared when it is unified in the embodiment of the present invention.

### DESCRIPTION OF EMBODIMENTS

Embodiments of the present invention are hereunder described by reference to the drawings.

### First Embodiment

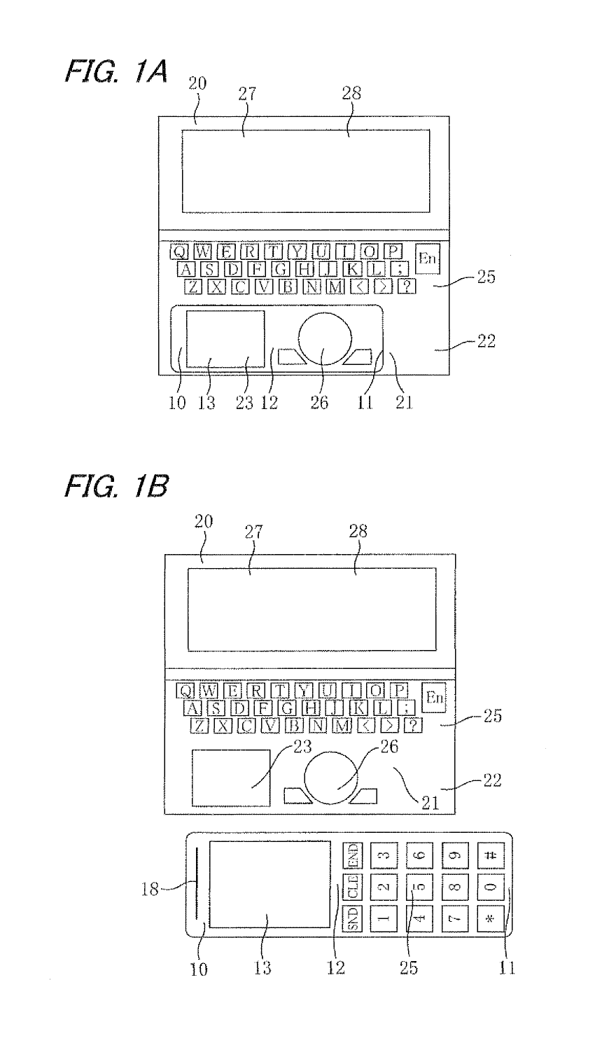

FIG. 1A is a schematic structural diagram of a unified state of a first embodiment of the present invention.

A master terminal 20 that is a first terminal is presumed to be a foldable mobile terminal. The master terminal 20 is equipped with a large screen display section 27 provided on a surface of an upper enclosure; and a key manipulation section (QWERTY key) 25, a touch pad/click device 26 that are all provided on a surface of a lower enclosure. A slave terminal 10 that is a second terminal is accommodated in the lower enclosure of the master terminal 20. In the present embodiment, the slave terminal 10 is inserted into the master terminal 20 from below. However, accommodation of the slave terminal is not limited to this structure. Any structure is fine, so long as the slave terminal is accommodated in the master terminal 20.

FIG. 1B is a separation diagram of the first embodiment of the present invention. A configuration of a cellular phone is taken as an example of the slave terminal 10, and a configuration, and the like, of the slave terminal will be described later.

A unification/separation detection section 11 and a unification/separation detection section 21 detect whether or not the slave terminal 10 is accommodated in the master terminal 20 (whether or not they are unified). The unification/separation detection section 11 and the unification/separation detection section 21 are disposed where they are physically connected together. Limitations are not necessarily imposed on a location where the unification/separation detection section 11 is placed. The essential requirement for the location is that the unification/separation detection section 11 be placed at any of an upper surface, a lower surface, and side surfaces of the slave terminal 10 and physically connected to the unification/separation detection section 21 of the master terminal 20, to thus form a unified structure.

In FIG. 1A, a compact touch panel 23 of the master terminal 20 is placed at a position overlapping a display section 13 of the slave terminal 10. The display section 13 can be any device, so long as the display section corresponds to a display device, like an LCD and an organic EL. The compact touch panel 23 can be any device, so long as the touch panel is a pressure sensitive or an electrostatic device for detecting a user's contact. The compact touch panel 23 is built like a transparent window and makes it possible to visibly ascertain that the display section 13 is situated beneath the compact touch panel 23.

The slave terminal 10 has a short range wireless communication section 12, and the master terminal 20 has a short range wireless communication section 22. The short range wireless communication section 12 and the short range wireless communication section 22 conceivably include infrared communication, a wireless LAN, Bluetooth (Registered Trademark), and the like.

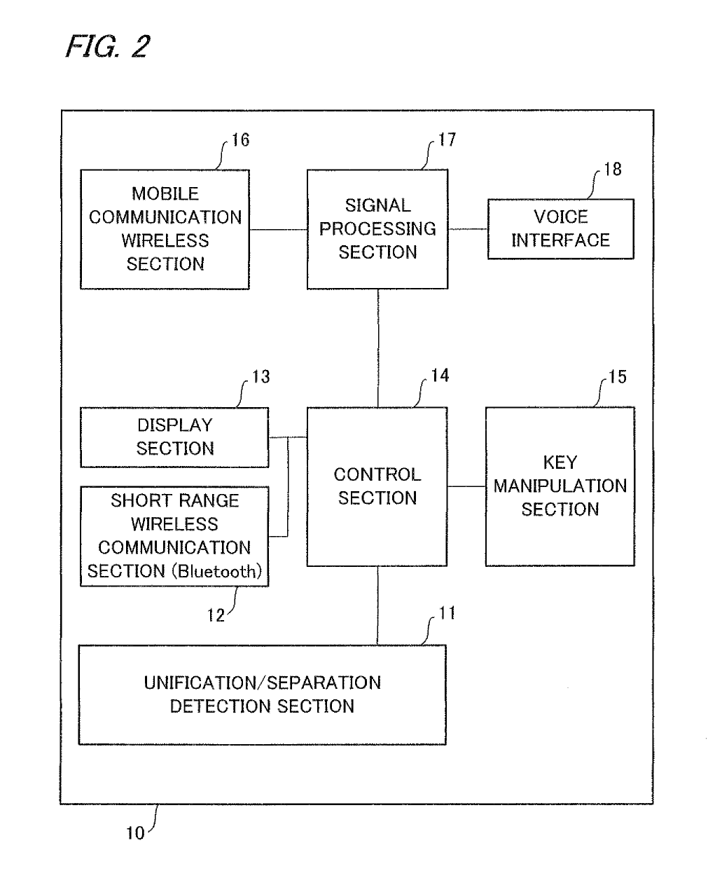

FIG. 2 is a hardware block diagram of the slave terminal 10 of the embodiment of the present invention.

FIG. 2 shows a configuration of a cellular phone that is an example of the slave terminal 10. The slave terminal 10 has a mobile communication wireless section 16, a signal processing section 17, and a voice interface 18.

Further, the slave terminal 10 has the unification/separation detection section 11, the short range wireless communication section (Bluetooth (Registered Trademark)) 12, the display section (LCD) 13, a control section 14, and a key manipulation section 15.

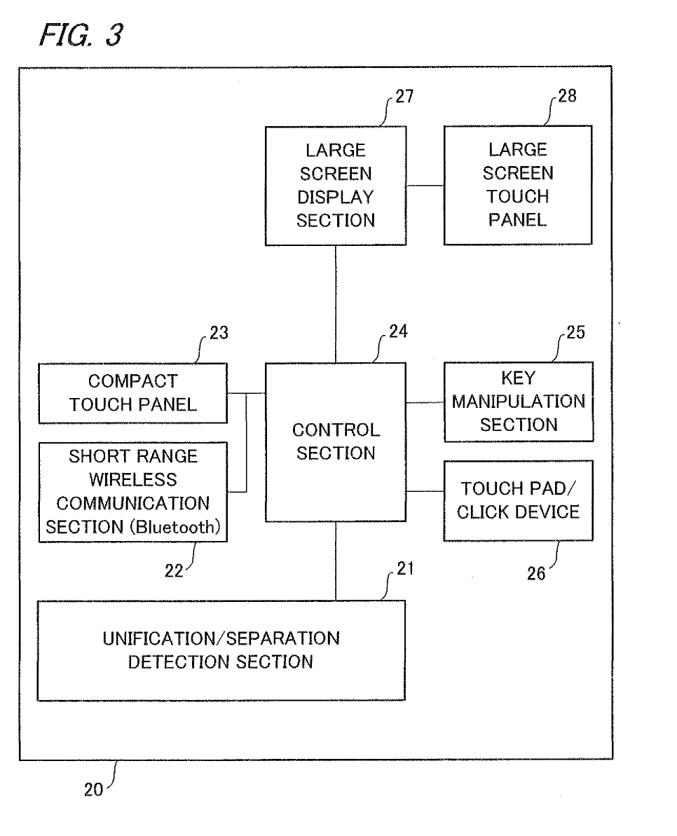

FIG. 3 is a hardware block diagram of the master terminal 20 of the first embodiment of the present invention. The master terminal 20 includes the unification/separation detection section 21, the short range wireless communication section (Bluetooth (Registered Trademark)) 22, the compact touch panel 23, a control section 24, the key manipulation section 25, the touch pad/click device 26, the large screen display section 27, and a large screen touch panel 28.

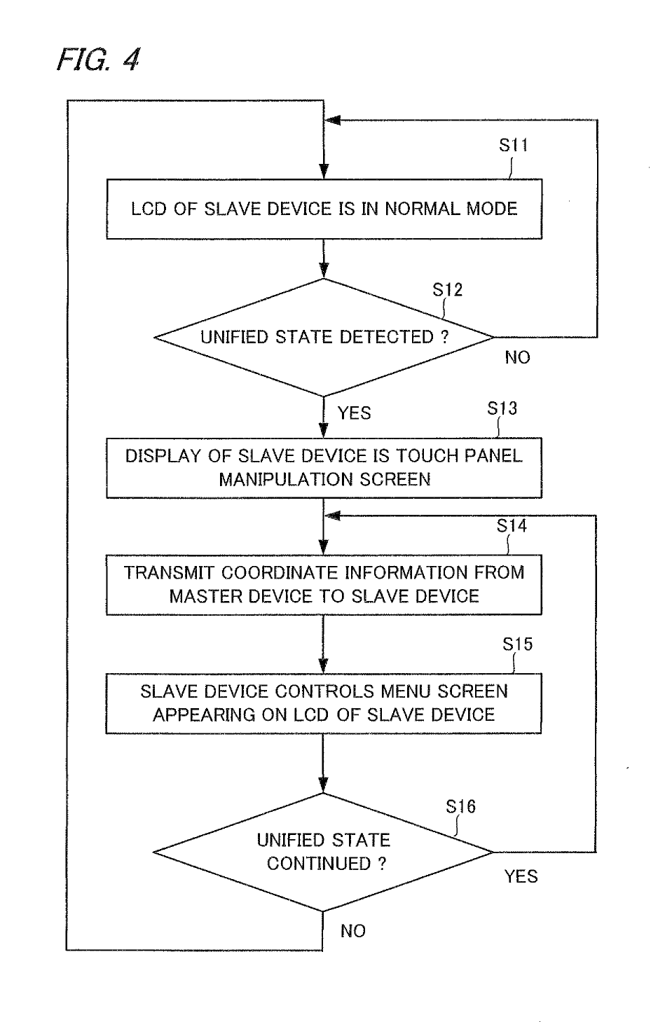

FIG. 4 is an operation processing flow chart of the first embodiment of the present invention.

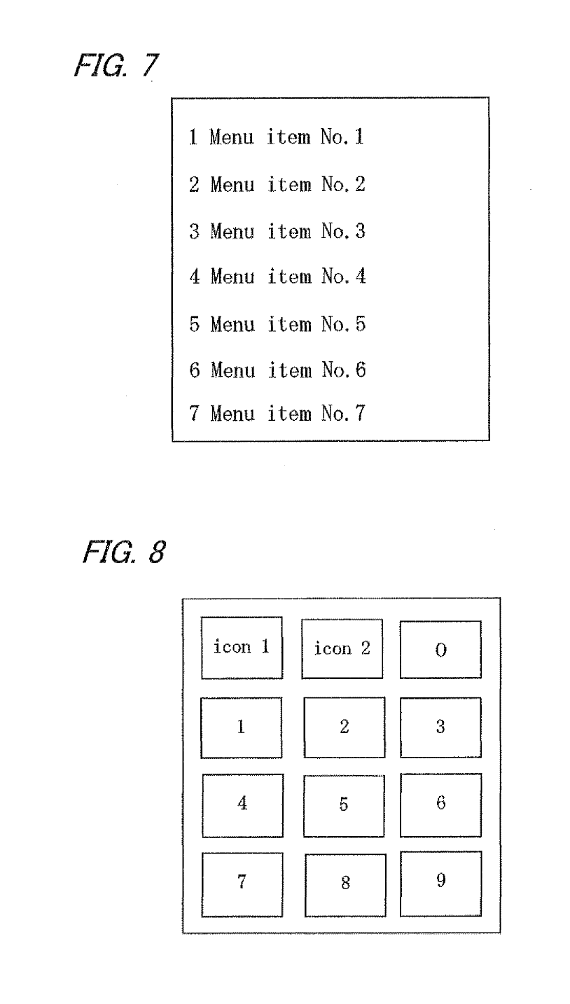

When the slave terminal 10 is in a separated state, the display section (LCD) 13 displays, in step S11, a normal menu display screen, such as that indicated by an example display of the slave terminal shown in FIG. 7. The unification/separation detection section 11 detects and thereby determines whether or not the slave terminal 10 is in a unified state (step S12), and the unification/separation detection section 21 detects and thereby determines whether or not the master terminal 20 is in a unified state (step S12). When a determination result yielded by the control section 14 of the slave terminal 10 shows that detection of unification is No, there is made a return to processing pertaining to step S11. When detection of unification rendered in step S12 is Yes, the slave terminal 10 is controlled by way of the short range wireless communication section (Bluetooth (Registered Trademark)) 22 under control of the control section 24 of the master terminal 20. By means of the control information received by way of the short range wireless communication section (Bluetooth (Registered Trademark)) 12 and under control made by the control section 14 of the slave terminal 10, the display section 13 is automatically switched to a touch panel menu display screen for unification, such as that indicated by an example display of the slave terminal shown in FIG. 8 (step S13). In step S13, under control of the control section 24 of the master terminal 20, the large screen display section (LCD) 27 can be switched to a display “Off” (a sleep mode). Information about coordinates of a point on the compact touch panel 23 of the master terminal 20 pressed by a finger (i.e., coordinates for the slave screen) is acquired, and the coordinate information is transmitted from the master terminal 20 to the slave terminal 10 under control of the control section 24 by way of the short range wireless communication section (Bluetooth (Registered Trademark)) 22 (step S14). By means of the coordinate information received by way of the short range wireless communication section (Bluetooth (Registered Trademark)) 12 and under control made by the control section 14 of the slave terminal 10, a touch panel menu display screen of the display section 13 is controlled (step S15). The unification/separation detection section 11 and the unit/separation detection section 21 detect and thereby determine whether or not the slave terminal 10 and the master terminal 20 stay continually unified (step S16). When Yes is rendered to continued unification in step S16, a return to processing pertaining to step S14 is made, and master-slave linked control of the touch panel menu display screen performed in the unified state is continued. When No is rendered to continued unification in step S16, the unification/separation detection section 11 and the control section 14 determine that the slave terminal 10 is in a separated state. A return to processing pertaining to step S11 is made, and automatic switching is made to the normal menu display screen, such as that shown by the example display of the slave terminal shown in FIG. 7.

By means of foregoing operation, there can be provided a unitable/separable terminal device that has a structure and a method of enabling control of linked communication between the master terminal and the slave terminal.

When the master device and the slave device are unified into the cellular phone, the display of the slave device is thereby automatically switched to the touch panel manipulation screen. Thus, input information about the touch panel can be output from the master device to the slave device. While the slave device is accommodated in the master device, the slave device can be operated without being detached from the master device. Further, the slave device is operated by means of the touch panel, whereby the slave device can be intuitively operated. Moreover, since the slave device does not need to be provided with a touch panel, the slave device can be miniaturized, so that it becomes easy to accommodate the slave device in the master device.

Although the compact touch panel 23 is equipped with a transparent window, any window is allowable, so long as the window makes presence of the display section 13 visible.

Further, it is also possible to detect whether or not the slave terminal 10 is accommodated in the master terminal 20 by employing infrared sensing, an illuminance sensor, or the like, for the unification/separation detection section 11 and the unification/separation detection section 21.

Furthermore, the unification/separation detection section 11 and the unification/separation detection section 21 may also be a single section. In this case, a result of detection of unification/separation can also be reported to another terminal by means of the short range wireless communication section 12 or 22.

### Second Embodiment

FIG. 2 is also common to a second embodiment of the present invention.

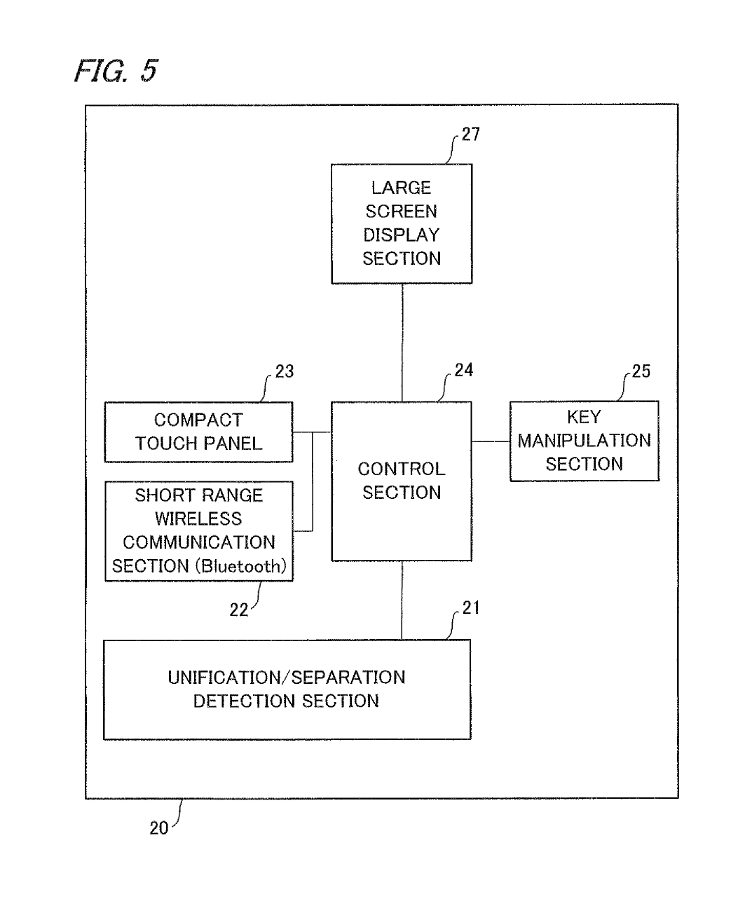

FIG. 5 is a hardware block diagram of a master terminal of the second embodiment of the present invention. The master terminal 20 includes the unification/separation detection section 21, the short range wireless communication section (Bluetooth (Registered Trademark)) 22, the compact touch panel 23, the control section 24, the key manipulation section 25, and the large screen display section 27.

A substantial structure of a unified terminal device of the second embodiment of the present invention is common to FIG. 1. However, the master terminal 20 is not equipped with the touch pad/click device 26 and the large screen touch panel 28.

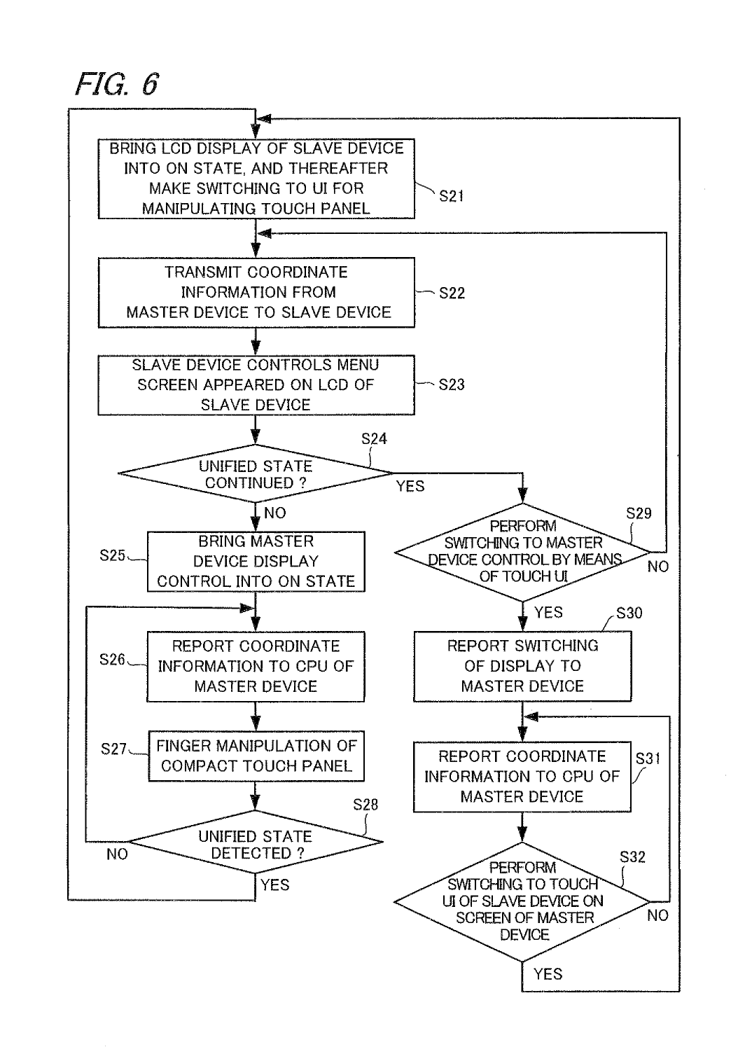

FIG. 6 is an operation processing flow chart of the second embodiment of the present invention.

When the unification/separation detection section 11 and the unification/separation detection section 21 respectively detect whether or not the slave terminal 10 and the master terminal 20 are unified and when detection results show that the unification/separation detection section 11 and the unification/separation detection section 21 are in a unified state, the slave terminal 10 is controlled by way of the short range wireless communication section (Bluetooth (Registered Trademark)) 22 under control of the control section 24 of the master terminal 20. The display section 13 is brought into a “Display ON” state by means of the control information received by way of the short range wireless communication section (Bluetooth (Registered Trademark)) 12 and under of the control section 14 of the slave terminal 10, whereupon the display automatically switches to a touch panel menu display screen for unification, such as that represented by an example display of the slave terminal shown in FIG. 8 (step S21). In step 521, the large screen display section 27 can be brought into a “Display Off (sleep)” state under control of the control section 24 of the master terminal 20. The display of the slave terminal achieved at this time is in a touch UI mode. Next, information about coordinates of a point on the compact touch panel 23 of the master terminal 20 (coordinates for the screen of the slave device) pressed through finger manipulations is captured. Under control of the control section 24, the coordinate information is transmitted from the master terminal 20 to the slave terminal 10 by way of the short range wireless communication section (Bluetooth (Registered Trademark)) 22 (step S22). The touch panel menu display screen of the display section 13 is controlled by means of the coordinate information received by way of the short range wireless communication section (Bluetooth (Registered Trademark)) 12 and under control of the control section 14 of the slave terminal 10 (step S23). The unification/separation detection section 11 and the unification/separation detection section 21 detect and subsequently determine whether or not the slave terminal 10 and the master terminal 20 continually remain in a unified state, respectively (S24).

When No is rendered as to continued unification in step S24, the unification/separation detection section 11 and the control section 14 determines that the slave terminal 10 is in a separated state. The screen automatically switches to the normal menu display screen, such as that represented by the example display of the slave terminal shown in FIG. 7. Concurrently, by means of the unification/separation detection section 21, the master terminal 20 also determines that the slave terminal 10 has been separated. Under control of the control section 24, the large screen display section 27 of the master terminal 20 is brought into a “Display On” state, thereby switching the compact touch panel 23 such that the touch panel can be operated as a device for controlling and clicking a cursor for operating a large screen of the master device (step S25). Next, information about coordinates of a point on the compact touch panel 23 of the master terminal 20 pressed through finger manipulations is acquired and thereafter reported to the control section 24 (step S26). By means of operation induced through finger manipulations on the compact touch panel 23 and under control of the control block 24, controlling and clicking of the cursor on the large screen display section 27 are performed (step S27). The unification/separation detection section 11 and the unification/separation detection section 21 respectively determine and subsequently detect whether or not the slave terminal 10 and the master terminal 20 are in a unified state (step S28). When, in step S28, the unification/separation detection section 21 of the master terminal 20 renders No as to detection of unification of the slave terminal 10, a return to processing pertaining to step S26 is made. When the unification/separation detection section 21 of the master terminal 20 renders, in step S28, Yes as to detection of unification of the slave terminal 10, the slave terminal 10 is controlled under control of the control section 24 of the master terminal 20 by way of the short range wireless communication section (Bluetooth (Registered Trademark)) 22, and a return to processing pertaining to S21 is made.

When Yes is rendered in relation to continued unification in step S24, the control section 14 of the slave terminal 10 determines whether or not switching has been made to master control by means of information about coordinates of a point on the compact touch panel 23 pressed through finger manipulations (step S29). When No is rendered in step S29, a return to processing pertaining to step S22 is made. When Yes is rendered in step S29, the display section 13 is brought into an off display state or a background color without a menu display under control of the control section 14 of the slave terminal 10. A display switch is reported from the slave terminal 10 to the master terminal 20 by way of communication between the short range wireless communication section (Bluetooth (Registered Trademark)) 12 and the short range wireless communication section (Bluetooth (Registered Trademark)) 22. Under control of the control section 24, the large screen display section 27 of the master terminal 20 is brought into a “display On” state, thereby switching the compact touch panel 23 such that the touch panel can operate as a device for controlling and clicking the cursor of the large screen of the master terminal (step S30). Next, information about coordinates of a point on the compact touch panel 23 of the master terminal 20 pressed through finger manipulations is acquired, and controlling and clicking of the cursor on the large screen display section 27 are performed under control of the control section 24 (step S31). By means of information about coordinates of a point on the compact touch panel 23 pressed through finger manipulations and controlling and clicking of the cursor on the large screen display section 27 of the master terminal 20 performed under control of the control section 24, the control section 24 of the master terminal 20 determines whether or not switching the compact touch panel 23 from manipulation of the master device large screen to the touch panel menu display screen for the display section 13 has been selected (step S32). When No is rendered in step S32, a return to processing pertaining to step S31 is made. When Yes is rendered in step S32, the slave terminal 10 is controlled by way of the short range wireless communication section (Bluetooth (Registered Trademark)) 22 under control of the control section 24 of the master terminal 20, thereby making a return to processing pertaining to S21.

Even a configuration in which the master device does not have any touch pad and any large screen touch panel for operating the master device, a compact touch panel can be switched from a touch panel manipulation screen for operating the slave device to a device which also doubles as a device for controlling and clicking a cursor for manipulating a large screen of the master device.

Although the present invention has been described in detail and with reference to specific embodiments, diverse modifications or corrections may be made by those of skilled in the art without departing from the spirit and scope of the present invention.

This application is based on Japanese Patent Application No. 2010-045158 filed on Mar. 2, 2010, the disclosure of which is incorporated herein by reference in its entirety.

### INDUSTRIAL APPLICABILITY

The present invention relates to a terminal device having a structure that enables unification and separation of a slave terminal having a display screen to and from a master terminal and is useful for an application for operating the slave device independently from the master device in a unified state.

### DESCRIPTIONS OF THE REFERENCE NUMERALS AND SYMBOLS

10 SLAVE TERMINAL

11 UNIFICATION/SEPARATION DETECTION SECTION

12 SHORT RANGE WIRELESS COMMUNICATION SECTION (Bluetooth (REGISTERED TRADEMARK))

13 DISPLAY SECTION (LCD)

14 CONTROL SECTION

15 KEY MANIPULATION SECTION

16 MOBILE COMMUNICATION WIRELESS SECTION

17 SIGNAL PROCESSING SECTION

18 VOICE INTERFACE

20 MASTER TERMINAL

21 UNIFICATION/SEPARATION DETECTION SECTION

22 SHORT RANGE WIRELESS COMMUNICATION SECTION (Bluetooth (REGISTERED TRADEMARK))

23 COMPACT TOUCH PANEL

24 CONTROL SECTION

25 KEY MANIPULATION SECTION

26 TOUCH PAD/CLICK DEVICE

27 LARGE SCREEN DISPLAY SECTION

28 LARGE SCREEN TOUCH PANEL

1. A terminal device comprising:
a first terminal having a touch panel and
a second terminal having a display screen,
wherein the second terminal can be accommodated in the first terminal;
the touch panel is positioned immediately above the display screen while the second terminal remains accommodated in the first terminal; and
the second terminal displays a touch panel manipulation screen on the display screen when the second terminal is accommodated in the first terminal, and the first terminal transmits to the second terminal input information entered by way of the touch panel.

2. The terminal device according to claim 1, wherein the first terminal and the second terminal each have short range wireless communication means; and the short range wireless communication means transmits the information detected by means of the touch panel from the first terminal to the second terminal.

3. The terminal device according to claim 1, wherein manipulation performed by way of the touch panel makes switchable between controlling of the first terminal and controlling of the second terminal,

4. A method of controlling a terminal system comprising
a first terminal having a touch panel and
a second terminal having a display screen,
where the second terminal can be accommodated in the first terminal and the touch panel is positioned immediately above the display screen while the second terminal remains accommodated in the first terminal,
wherein the method comprises:
a detection step of detecting that the second terminal is accommodated in the first terminal;
a display step of displaying a touch panel manipulation screen on the display screen when the second terminal is detected to be accommodated in the detection step and
a transmission step of transmitting input information entered by way of the touch panel to the second terminal when the second terminal is detected to be accommodated in the detection step.

5. The terminal device according to claim 2, wherein manipulation performed by way of the touch panel makes switchable between controlling of the first terminal and controlling of the second terminal.
